(19) United States
(12) Patent Application Publication
(10) Pub. No.: US 2013/0248695 A1
(43) Pub. Date: Sep. 26, 2013

(54) METHOD AND APPARATUS FOR ANALYTE DETECTION

(71) Applicants: Duncan Macintyre, Campbellville (CA); Ash Kaushal, Mississauga (CA)

(72) Inventors: Duncan Macintyre, Campbellville (CA); Ash Kaushal, Mississauga (CA)

(21) Appl. No.: 13/882,466

(22) PCT Filed: Oct. 28, 2011
(86) PCT No.: PCT/CA2011/050680

§ 371 Date: Jun. 7, 2013

Related U.S. Application Data
(60) Provisional application No. 61/408,488, filed on Oct. 29, 2010.

(51) Int. Cl. G01N 21/17

(52) U.S. Cl. CPC G01N 21/17
USPC 250/227.11; 250/216

(57) ABSTRACT

Methods and apparatus for identifying an analyte in a sample are provided. The apparatus comprises an electromagnetic radiation (EMR) source in optical communication with a receptor. The receptor for receiving a sample and detecting if the sample has been presented to the receptor in a predefined manner. The receptor further directing the EMR received from the EMR source to the sample. The apparatus also comprises a detector in optical communication with the receptor, the detector for capturing transmitted, reflected, scattered EMR, or a combination thereof from the sample received from the receptor. The apparatus further comprises a user interface for presenting information obtained from the sample and the receptor, and the characteristics of one or more analytes in the sample, and a communications unit in operative association with the detector for transmitting the characteristics of one or more analytes in the sample to a processor or spectrograph.

### TECHNICAL FIELD

The present invention relates to methods and devices for detecting analytes in a sample.

### BACKGROUND

Current methods of detection of food, water and airborne pathogens or analytes within food or body fluid samples are generally reagent-based, and may require the use of specialized lab equipment. Further, identification of a microbe may require that the microbe be isolated and cultured.

Detection and identification of substances by infrared (IR) or Raman spectroscopy is well-established. The IR or Raman spectrum of a substance is characterized by a unique pattern of absorption bands that reflects the physico-chemical environment of the chemical functional groups comprising the substance. Non limiting examples of such methods include U.S. Pat. No. 7,198,955, U.S. Pat. No. 7,157,282, U.S. Pat. No. 6,741,876, U.S. Pat. No. 6,651,015, U.S. Pat. No. 6,611,777, U.S. Pat. No. 5,459,677, U.S. Pat. No. 5,429,128, (which are incorporated herein by reference).

Various studies have demonstrated the feasibility of detection and identification of bacteria using infrared spectroscopy. Fourier-transform mid-infrared (FT-IR) spectroscopy has been use to detect and classify bacteria (Naumann D., et. al., Nature 1991, 351(6321):81-2; Helm D., J Gen Microbiol. 1991, 137(1):69-79), and to detect bacteria in meat (Ellis D. I., Appl Environ Microbiol. 2002, 68(6):2822-8). FT-IR has also been used to detect pure cultures of bacterial pathogens inoculated into bottled drinking water (Al-Qadiri H. M., J Agric Food Chem. 2006, 54(16):5749-54).

Devices and methods that enable real-time detection and identification of bacterial pathogens or other analytes are desired, to determine sources of contamination, and to ensure appropriate public health measures taken.

### SUMMARY OF THE INVENTION

The present invention relates to methods and apparatuses for detecting analytes in a sample. The analyte may be a microbial pathogen, a food sample, a sample of a body fluid, water, or a combination thereof.

The present invention provides an apparatus (A) for determining the characteristics of one or more analytes in a sample, comprising,

an electromagnetic radiation (EMR) source;

a receptor in optical communication with the EMR source, the receptor for receiving a sample, detecting if the sample has been presented to the receptor in a predefined manner, and directing EMR received from the EMR source at the sample;

a detector in optical communication with the receptor, the detector for capturing transmitted EMR, reflected EMR, scattered EMR, or a combination thereof, obtained from the sample;

a user interface for presenting information respecting the presentation of the sample to the receptor, and the characteristics of one or more analytes in the sample; and

a communications unit in operative association with the detector for transmitting the characteristics of one or more analytes in the sample to one or more processors or one or more spectrophotometer.

The receptor of the apparatus as just defined may comprise a glide path or channel for directing the sample into proper orientation with the receptor. Furthermore, the receptor may further comprise a warning system to notify a user whether the finger, body part, or sample holder has not properly covered over the aperture of the receptor.

The sample holders that are positioned over or within the receptor may comprise one or more sample wells and one or more sample input ports through which samples are loaded into the sample wells. Depending on the configuration of the sample holder, the same or different samples may be analyzed at one time. One or more wavelengths of EMR may be selected and used for determination of an analyte within a sample. For example, the apparatus of the present invention may be configured to detect the type of sample holder positioned over or inserted within the receptor such that a pre-set one or more wavelengths of EMR is selected and used to determine the identity, concentration, or both the identity and concentration of one or more analytes in the one or more samples within the one or more sample wells.

The present invention provides the apparatus as just defined, wherein the communications unit is in operative communication with a corresponding communications unit in a hand held device, a cell phone, a mobile device, or a computing device, the hand held device, cell phone, mobile device, or computing device comprising one or more spectrophotometer in communication with the receptor, detector and user interface, the one or more spectrophotometer for determining one or more property of one or more analytes in the sample based on the measured reflected or scattered EMR received from the detector, directing the user interface to present information received from the receptor respecting the presentation of the sample to the receptor, and directing the user interface to present information respecting the one or more property of one or more analytes in the sample determined by the processor (Apparatus B).

Alternatively, the apparatus (A) as defined may comprise one or more spectrophotometer in communication with the receptor, detector and user interface, the one or more spectrophotometer for determining one or more property of one or more analytes in the sample based on the measured reflected or scattered EMR received from the detector, directing the user interface to present information received from the receptor respecting the presentation of the sample to the receptor, and directing the user interface to present information respecting the one or more property of one or more analytes in the sample determined by the processor (Apparatus C).

The present invention also pertains to the apparatus (B), wherein the hand held device, cell phone, mobile device, or other computing device comprises a processor, the processor comprising application software for determining one or more property of the analyte, and a user interface.

The present invention also provides the apparatus (B), wherein the one or more property of the analyte is transmitted to a second computing device over the interne. The one or more property of the analyte may also be transmitted to a second computing device wirelessly.

The apparatus (A) as defined above may also be housed within a hand-held device, a cell phone, a mobile device, or a computing device. Furthermore the apparatus (B) as defined above may also be housed within a hand-held device, a cell phone, a mobile device, or a computing device.

Furthermore, the apparatus as defined in (A) or (B) may comprise one or more fibre optics connectors in optical communication with the EMR, each of the one or more fibre optics providing one or more different wavelengths of EMR to one or more ports within the receptor, the receptor further comprising one or more outlet ports coupled to one or more output fibre optics each in optical communication with one or more spectrometers.

An advantage of the present invention is that sample measurements may take place using either transmission, reflectance, or transmission and reflectance to detect a specific analyte in one or more samples. Obtaining both transmission and reflectance data may be obtained using two or more spectrometers each operatively communicating with output path to enable a simultaneous absorption and reflectance measurement, or a single spectrometer may be used in operative communication with two or more fibre bundles each receiving either transmitted or reflected EMR after interaction with the sample. In this example, the receptor (finger interface) is configured to enable absorption and reflectance EMR to be obtained from a sample, as consecutive measurements. This combination of information provides increased accuracy of an analyte to determine for example the impact of interstitial fluid on a blood glucose prediction.

Furthermore, by having a warning system to ensure proper sample placement over or within the receptor, the apparatus of the present invention may be used under conditions that are not normally associated with sample analyte determination, and permit the apparatus to be fitted to a mobile or portable devices such as for example, a cell phone or smart phone.

Furthermore, any wavelength in the UV/VIS/NIR or beyond may be used in the apparatus described herein to detect and measure blood analytes and or pathogens using a portable device.

Systems, methods and devices are also provided for confirming and complementing the detection and measurements of select analytes within one or more samples using the apparatus of the present invention.

This summary of the invention does not necessarily describe all features of the invention. Other aspects, features and advantages of the present invention will become apparent to those of ordinary skill in the art upon review of the following description of specific embodiments of the invention.

### BRIEF DESCRIPTION OF THE DRAWINGS

FIG. 1A provides an example of a system diagram of a mobile device for the detection of analytes in a sample. FIG. 1B provides an example of a system diagram of the components of a receptor of the mobile device shown in FIG. 1A. FIG. 1C provides an example of a system diagram of a mobile device for the detection of analytes in a sample, in transmission mode; FIG. 1D provides an example of a system diagram of a mobile device for the detection of analytes in a sample, in reflective mode. FIGS. 1E and 1F show alternate examples of the apparatus.

FIG. 2 shows an example of a system diagram of a mobile device for the detection of analytes in a sample

FIGS. 3A to 3F provide diagrams of examples of a receptor of either of the devices referred to FIGS. 1 and 2.

FIGS. 4A to 4F provide diagrams of examples of a receptor of either of the apparatuses shown in FIGS. 1 and 2.

FIGS. 5A to 5D provide diagrams of examples of a receptor of either of the apparatuses shown in FIGS. 1 and 2.

FIGS. 6A to 6E provide diagrams of variants of a receptor of either of the apparatuses shown in FIGS. 1 and 2.

FIGS. 7A to 7E provide side perspective views of variants of sample holders for use with the devices shown in FIGS. 1 and 2.

FIGS. 8A to 8D provide diagrams of variants of a receptor of either of the devices shown in FIGS. 1 and 2.

FIGS. 9A to 9D provide diagrams of a receptor of either of the devices shown in FIGS. 1 and 2.

FIG. 10 provides a logic diagram of a method of detection of analytes in a sample using either of the devices shown in FIGS. 1 and 2.

FIG. 11 provides a non-limiting example of an alternate device and variant of a sample holder according to the present invention.

### DETAILED DESCRIPTION

The present invention relates to methods and devices for detecting analytes in a sample. The analyte may be for example, but not limited to, a microbial pathogen, a food sample a sample of a body fluid, water, or a combination thereof.

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

As used herein, the term “sample” means a biological or non-biological fluid, a biological or non-biological semi-solid, or a biological or non-biological solid exhibiting one or more properties that may be measured spectroscopically. A sample typically comprises one or more analytes. Examples of a sample include, but are not limited to, a calibrator, water, a body fluid, whole blood, serum, plasma, urine, synovial fluid, lymphatic fluid, sputum, feces, cerebrospinal fluid, a food sample, a dairy product, milk, cheese, yogurt, ice cream, wine, a beverage, or semi soft food.

As used herein, the term “analyte” means a substance, compound or organism being measured in a sample, and includes, without limitation, a pathogen, a bacteria, a nosocomial pathogen, food or waterborne pathogens, opportunistic pathogens, or another microbe. For example, which is not to be considered limiting, an analyte may include: Listeria monocytogenes, Salmonella spp, Clostridium spp. Escherichia coli O157:H7, Vibrio spp. Campylobacter spp., Pseudomonas spp, Bacillus spp, Cyanobacteria, Cryptosporidium, Legionella spp., Aeromonas spp., or the like. An analyte may also include a compound, or an element, for example a carbohydrate, a protein, a glycoprotein, hemoglobin, Oxy-Hb, % oxy-Hb, “Oxy-Hb plus Deoxy-Hb”, “Total-Hb minus Met-Hb”, Met-Hb, % met-Hb, Carboxy-Hb, Co-Hb, Sulf-Hb, HbA_{1c}, cholesterol, glucose, a lipoprotein, a steroid, an amino acid, nitrogen, carbon dioxide, cortisol, creatine, creatinine, a ketone, a lipid, urea, a fatty acid, glycosolated hemoglobin, alcohol, lactate, an ion, Ca²⁺, K⁺, Cl⁻, HCO₃⁻, HPO₄⁻ and a neutral or ionic form of a heavy metal, for example, but not limited to a neutral or ionic form of a metal having an atomic number greater than 20 (calcium), more particularly a metal having an atomic number between 21 (scandium) and 92 (uranium), such as a neutral or ionic form of mercury, arsenic, lead or cadmium, a fatty acid for example an omega-3 fatty acid, for example, but not limited to α-linolenic acid, eicosapentaenoic acid, or docosahexaenoic acid; an omega-6 fatty acid, for example, but not limited to linoleic acid, gamma-linolenic acid, eicosadienoic acid, dihomo-gamma-linolenic acid, arachidonic acid, docosadienoic acid, adrenic acid, or docosapentaenoic acid; or an omega-9 fatty acid, for example, but not limited to oleic acid, eicosenoic acid, mead acid, erucic acid or nervonic acid, glycosolated hemoglobin, alcohol, lactate, an ion, Ca²⁺, K⁺, Cl⁻, HCO₃⁻, HPO₄⁻, and an antioxidant such as Vitamin A (Retinol), Vitamin C (Ascorbic acid), Vitamin E (for example but not limited to alpha-, beta-, gamma- or delta-tocopherol; or alpha-, beta-, gamma- or delta-tocotrienol), a vitamin cofactor (for example but not limited to Coenzyme Q10 (CoQ10) or manganese), a hormone (for example but not limited to melatonin), a carotenoid terpenoid (for example but not limited to lycopene, lutein, alpha-carotene, beta-carotene, zeaxanthin, astaxanthin, or canthaxantin), a non-carotenoid terpenoid (for example but not limited to eugenol), a flavonol (for example but not limited to resveratrol, pterostilbene, kaempferol, myricetin, isorhamnetin, proanthocyanidins, or condensed tannins), a flavone (for example but not limited to quercetin, luteolin, apigenin, or tangeritin), a flavanone (for example but not limited to hesperetin, naringenin, or eriodictyol), a flavan-3-ol (for example but not limited to catechin, gallocatechin, epicatechin and its gallate forms, epigallocatechin and its gallate forms, theaflavin and its gallate forms, or thearubigins), isoflavone phytoestrogens (for example but not limited to genistein, daidzein, or glycitein), anthocyanins (for example but not limited to cyanidin, delphinidin, malvidin, pelargonidin, peonidin, or petunidin), phenolic acids and their esters (for example but not limited to ellagic acid, gallic acid, salicylic acid, rosmarinic acid, cinnamic acid and its derivatives, chlorogenic acid, chicoric acid, gallotannins, or ellagitannins), curcumin, anthoxanthins, betacyanins, silymarin, or citric acid.

### Overview

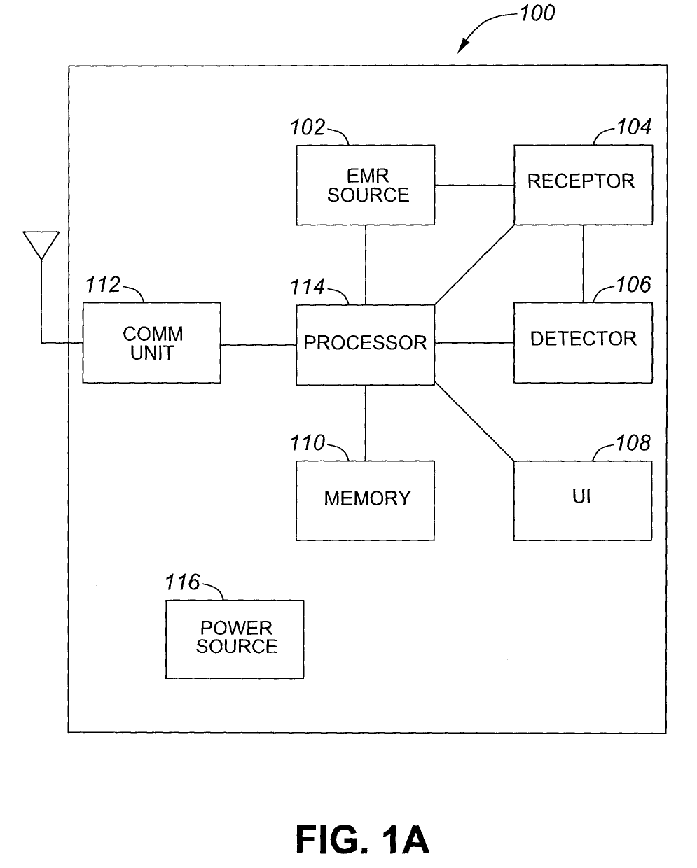

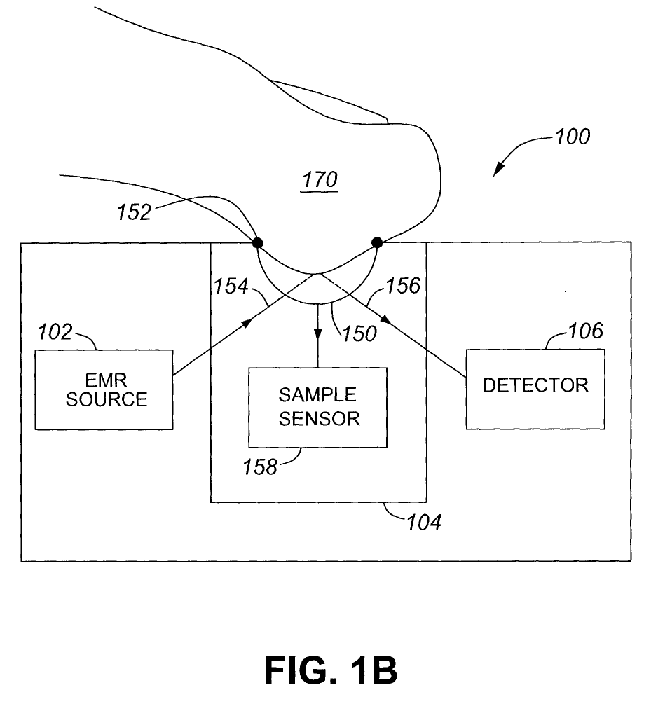

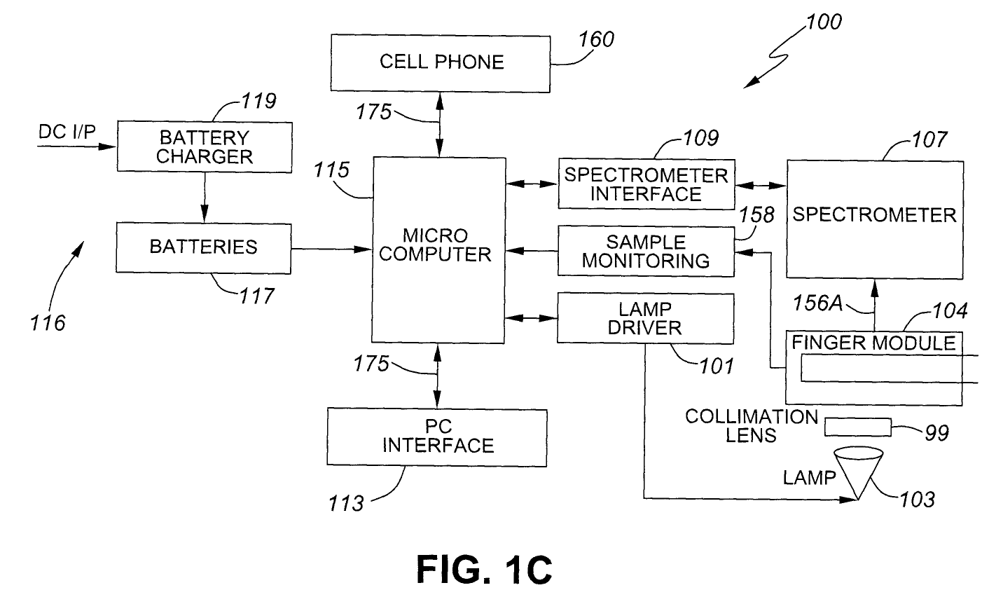

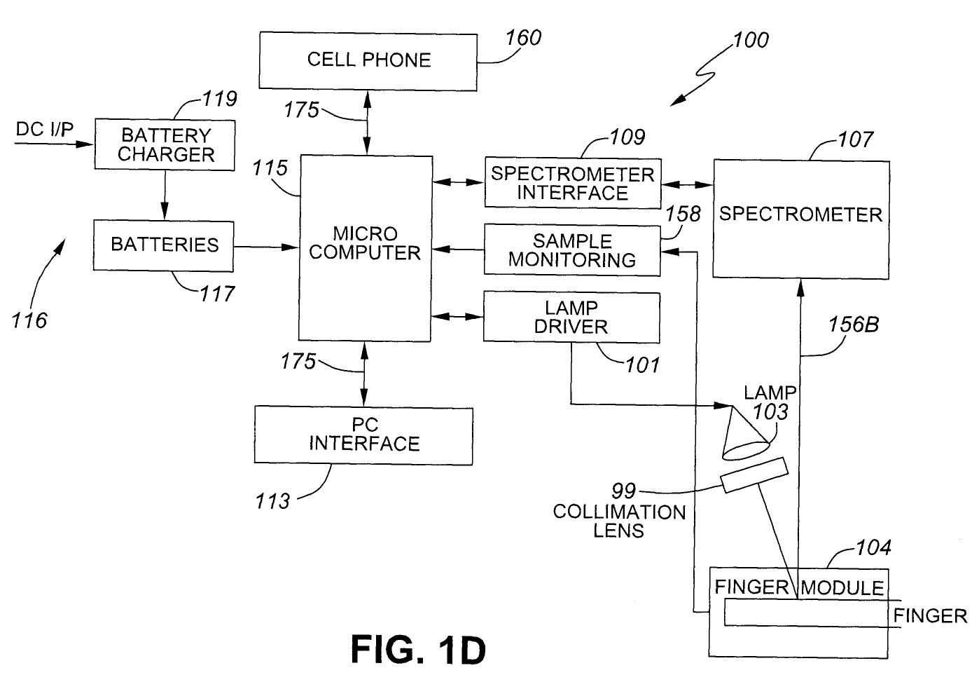

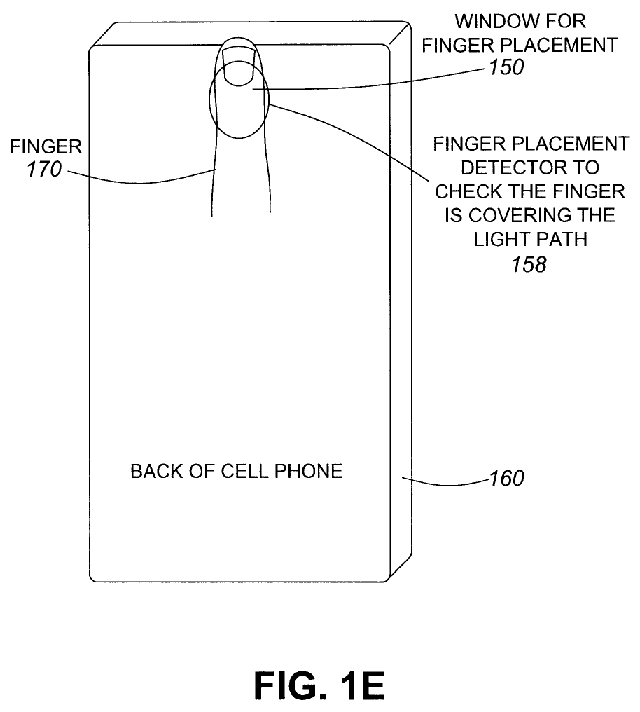

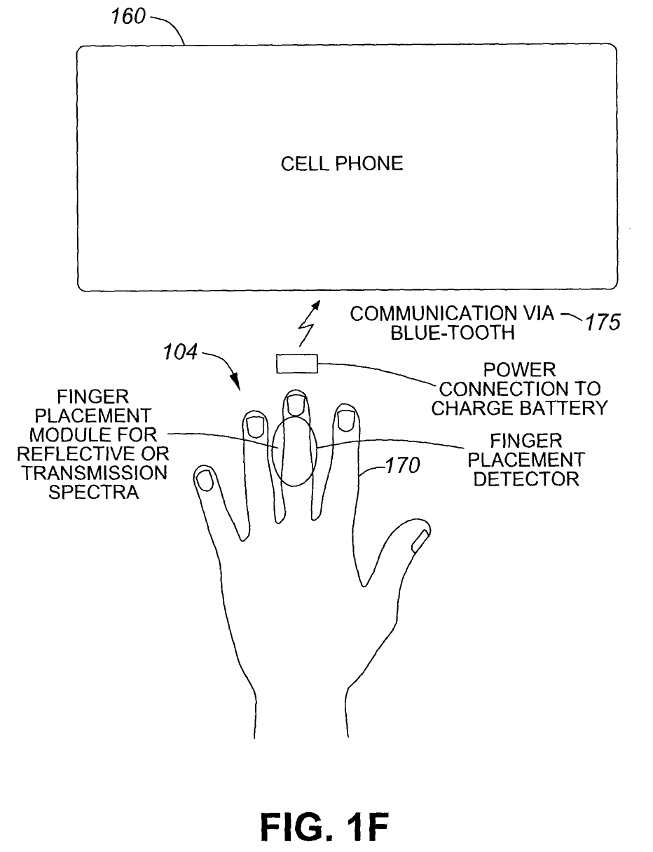

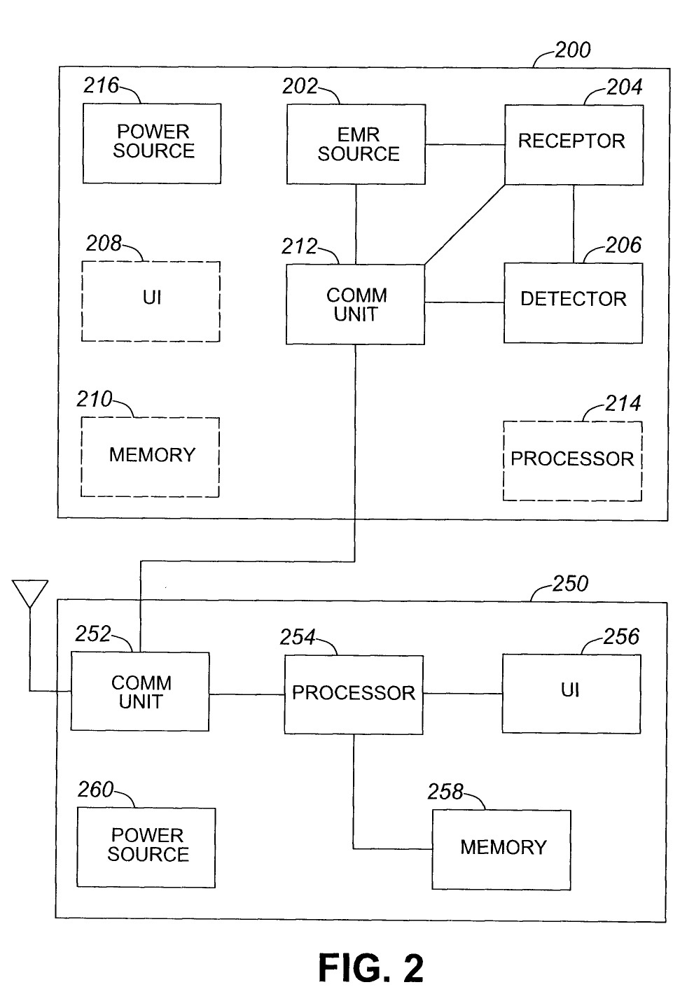

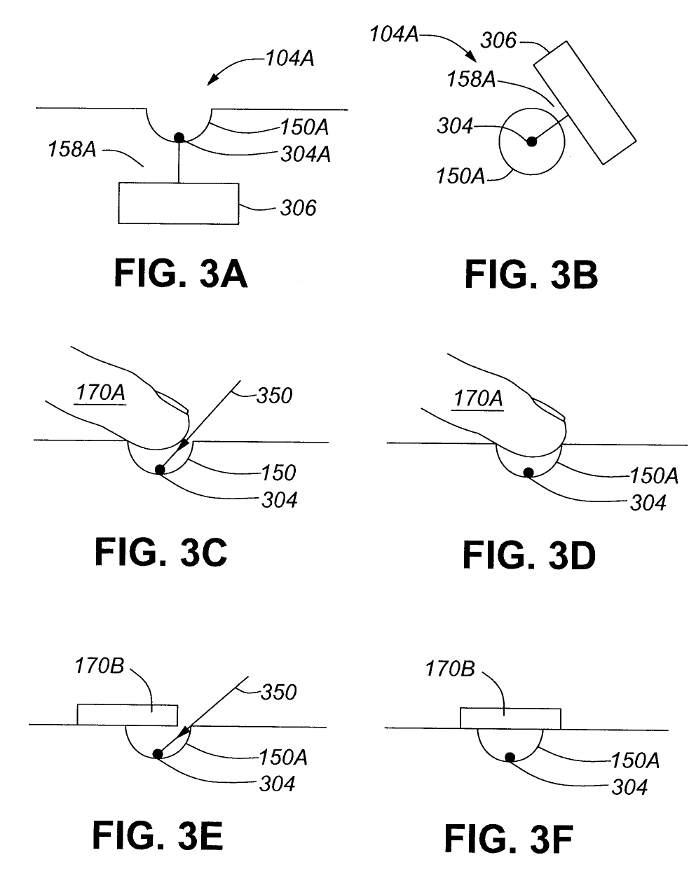

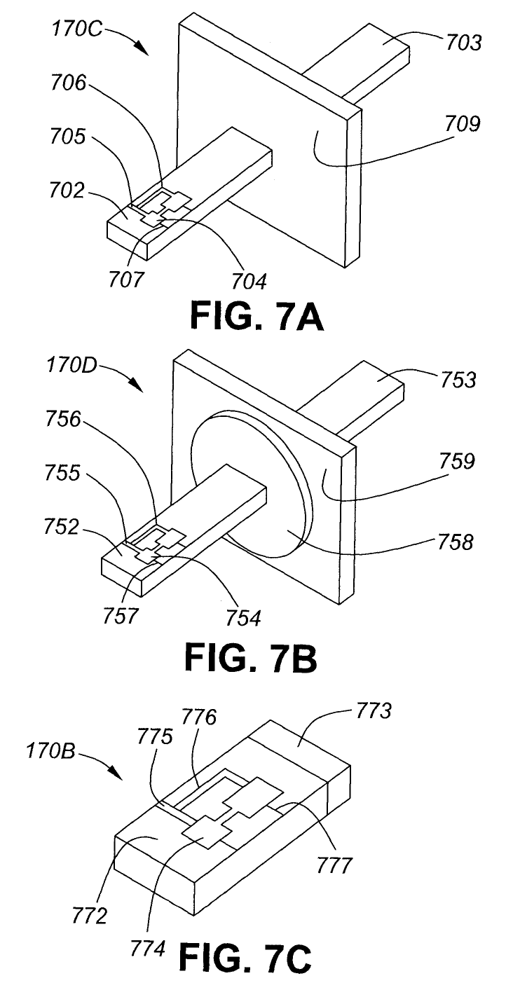

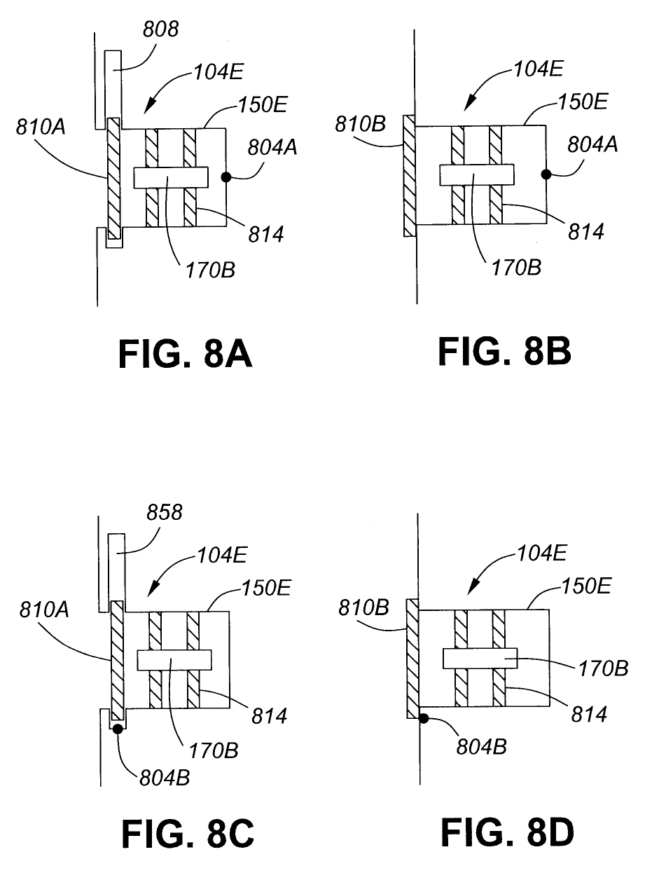

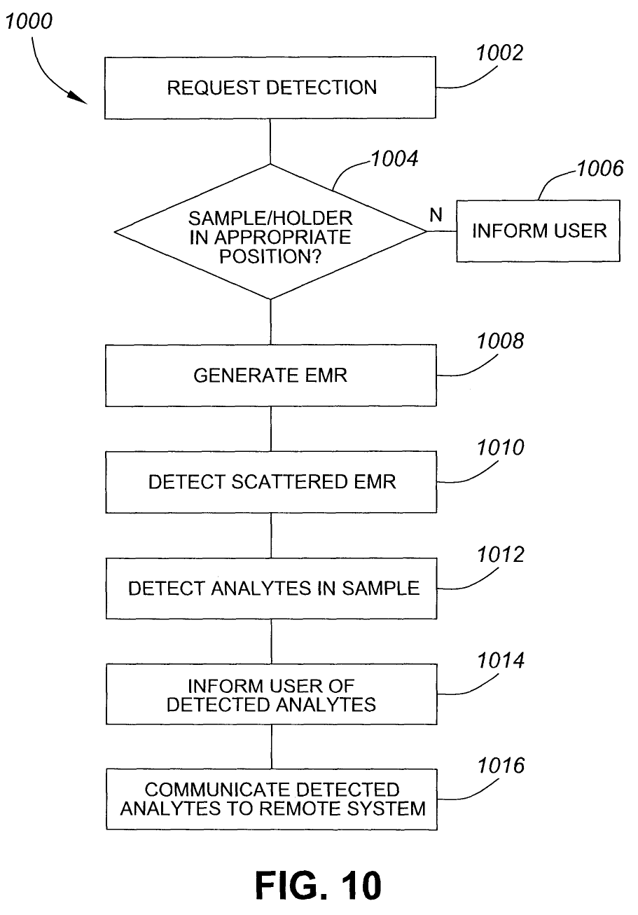

As described in more detail below, and with reference to the Figures, the present invention provides an apparatus (for example, 100, 200 and 250) for determining one or more analytes in a sample. The apparatus may comprise a device (e.g. 200) that attaches (e.g. FIG. 1A) or links with (e.g. FIGS. 1C, 1D, and 2) a cell phone (160) or other computing device (113) via wired or wireless means (175, 220). The device (200) may comprise a spectrometer (107), a light (or EMR) source (e.g. 101, 102, 103, 202) and other components as described below to obtain data regarding one or more analytes in a sample. The cell phone (160) or other computing device (113) may comprise application software for analyte monitoring, along with an appropriate user interface (e.g. 108, 256). The device may comprise blue tooth or other means for wireless connection, and/or a USB, Firewire or Ethernet connection for hard wire connectivity or memory-stick data transfer, to the cell phone or other computing device (175, 220). The device may (e.g. 200, or FIG. 1F) or may not (e.g. 100) operate independently from the cell phone or other computing device. For example, if the device is a part of the cell phone or other computing device (e.g. FIG. 1E), then the components required for analyte detection (monitoring capability) will also be a part of the cell phone or other computing device (e.g. apparatus 100). Alternatively, if the device is separate from the cell phone or other computing device (e.g. FIGS. 1F, 2), then the components required for analyte detection (monitoring capability) may be a part of the cell phone or other computing device (e.g. apparatus 250) and the components for analyte sampling including the receptor (104), EMR source (102) and spectrophotometer (107), microcomputer (115) or processor (114) may be a part of the device (200). The cell phone comprising the components required for analyte detection (e.g. 100), or the device (200), if used independently from the cell phone or other computing device (e.g. 160, 113, 250), will comprise a receptor (104, 204) having a glide path or channel, that may be molded into the device, that guides the finger, thumb, or sample holder (e.g. FIGS. 7, 8) into place over an aperture of the receptor (see FIGS. 3-6). The guide will stop just past the aperture to provide a comfortable placement for the finger, thumb, other body part, or a sample holder for in vitro analyte determination. The receptor of the device may also comprise a warning system to notify the user whether the finger, body part, or sample holder has not properly covered over the aperture of the receptor (see FIGS. 3-6 and 10). The data determined using the device in combination with the cell phone or other computing device regarding the one or more analytes detected within the sample may be downloaded via the interne to a computing device (e.g. 112, 252, 1016, FIG. 10). The device (100, 200) may be configured to monitor multiple analytes within a sample using one or more spectrometers (107) and if required, one or more fiber optics connectors (154, FIG. 1B) to provide light from an EMR or light source (101, 102, 103, 202) to either one or more port(s) within the receptor (e.g. 104, 204). The sample may be an in vitro sample provided on a sample holder, or an in vivo sample such as a finger, thumb or other body part. If the sample is an in vivo sample, then the pulse may also be determined if desired.

### Analyte Detection Apparatus

Referring to FIGS. 1A-1F, examples of a device for detecting analytes in a sample are generally shown as item 100. The apparatus 100 is capable of receiving one or more samples, detecting if the samples are presented in a predefined manner, determining the characteristics or concentrations of one or more analytes in the sample, communicating information respecting the sample to the user of the apparatus 100 and, optionally, communicating information respecting the sample to a remote system. The apparatus 100 generally comprises an electromagnetic radiation (EMR) source 102, which may include a lamp driver (101) and a lamp (103), a receptor 104, for example but not limited to a finger module or sample tab, a detector 106, which may be housed or included with a spectrophotometer 107, a user interface (UI) 108, a memory 110, a communications unit 112, a processor 114, and if required a communication pathway 175 (FIG. 1F), the user interface, memory, communications unit and processor may be provided as a micro computer 115 or separately, and a power source 116, which may include batteries 117, solar powered batteries, a battery charger 119, a USB, an electrical plug and the like.

The EMR source 102 is responsible for emitting EMR which is directed to the receptor 104 through an optical coupling between the EMR source 102 and the receptor 104. The EMR source 102 is in communication with and controlled by the processor 114 as further described below. The EMR source may emit EMR having one or more desired wavelengths. In the present embodiment, the EMR source 102 may comprise one or more than one light emitting diodes (LEDs), each LED emitting a desired wavelength of EMR. In the alternative, the EMR source 102 may comprises a laser source, an LED source, a monochromatic source, a polychromatic source operatively coupled with a diffraction grating or cut off filter, or another suitable source of EMR for irradiating a sample, located at the receptor 104, at one or more than one desired wavelengths. In addition, the EMR source 102 may further comprise one or more lenses for collimating (99), concentrating, aligning or conditioning the EMR prior to directing the EMR to the receptor 104 as would be known to one of skill in the art.

The EMR source 102 may emit EMR having one or more wavelengths over a range of wavelengths from about 300 nm to about 20,000 nm, or any wavelength therebetween as desired. For example, from about 300 to about 3000 nm, or any wavelength therebetween, or from about 500 nm to about 2500 nm or any wavelength therebetween. The infrared region of the electromagnetic spectrum is generally considered to be the spectral interval extending from 650 nm through to 1 mm. Measurement of samples using the near-infrared region may be obtained from about 700 nm to about 1100 nm range. The near infrared region is particularly well-suited to invasive and non-invasive diagnostic applications because biological samples or human tissue are somewhat transparent to the incident radiation and therefore sufficient penetration of the radiation is possible to allow accurate quantitative analysis.

Use of other ranges of EMR is also contemplated, for example, the shortwave infrared (SWIR)—about 1400 to about 3000 nm; the mid-wavelength infrared (MWIR)—about 1400 nm to about 3000 nm; ultraviolet range—about 10 to about 400 nm; or visible range—about 400 to about 700 nm.

The EMR source 102 and the range of wavelengths emitted by the EMR source 102 is not to be considered limiting in the present invention. For example, a polychromatic light source may be used. This type of light source can emit light over a wide bandwidth, including light in the near infrared spectrum. The polychromatic light source may comprise a quartz-halogen or a tungsten-halogen bulb to provide the broad spectrum of light in the near infrared. This polychromatic light source may be a tungsten-halogen lamp or it may be a collection of LEDs or other light sources selected to emit EMR in, for example, the near-infrared range of about 650 to about 1100 nm. More particularly, the polychromatic light source comprises a source of light that emits a wavelength of light in the visible red spectrum, for example, 660 nm, a wavelength of light in the infrared spectrum, for example, 940 nm, and a broad spectrum of light in the near infrared region.

The receptor 104 is responsible for receiving one or more samples (e.g. finger 170), detecting whether the samples are presented to the receptor 104 in a predefined manner, directing EMR received from the EMR source 102 at the sample, and directing EMR that is transmitted, reflected, scattered or a combination thereof by the sample to the detector 106 which may be included within spectrophotometer 107. The receptor 104 is optically coupled to the EMR source 102 to receive EMR emitted from the EMR source 102 (“incident EMR”), optically coupled to the detector 106 to direct EMR transmitted (156A, FIG. 1C; see also FIG. 1B), reflected (156B, FIG. 1C), or scattered through interaction of the incident EMR with a sample to the detector 106, and in communication with the processor 114 to communicate information respecting the presentation of the sample to the receptor 104. The receptor may also be configured to provide both transmitted and reflected EMR leaving the same sample, to the detector 106, or spectrophotometer 107. For example, the receptor may comprise two output or outlet paths 156A and 156B to receive transmitted and reflected EMT, respectively, for a sample, and the transmitted and reflected EMR may be obtained in a sequential manner from the sample. By obtaining data from both transmitted and reflected EMR from the same sample, at approximately the same time, increased accuracy of the analyte measurement is obtained.

Referring to FIG. 1B, the receptor 104 generally comprises a receptor inlet 150, one or more EMR inlets 154, one or more EMR outlets 156, a sample sensor 158 (sample monitoring FIGS. 1C and 1D), and, optionally, a sample guide 152. The receptor inlet 150 defines a physical space for the sample to be presented to the receptor 104. The receptor inlet 150 may be a shaped aperture in the apparatus 100, a structure extending from the external surface of the apparatus 100, a designated location on the external surface of the apparatus 100, or a physically separate (stand-alone) receptor that is in communication, for example wireless communication, with a processor (114). The receptor inlet 150 may be configured to specifically accept either an in vivo sample or an in vitro sample holder. Alternatively, the receptor inlet 150 may be configured to accept both in vivo samples and in vitro sample holders. The receptor may be physically housed within apparatus 100 for example a cell phone 160 (FIG. 1E), or it may be a separate device (e.g. 104 FIG. 1F, or 200 FIG. 2) and communicate, for example with a cell phone 160 (or a modular device 250, FIG. 2), by one or more wireless communication devices (175, FIGS. 1C, 1D, 1F; 220, FIG. 2) know in the art, such as, for example, cellular, bluetooth, infrared, satellite, shortwave radio, or via USB, Firewire, or Ethernet as required.

The one or more EMR inlets 154 are optically coupled to the EMR source 102 and receptor inlet 150 and function to direct the incident EMR emitted by the EMR source 102 towards a sample 170 presented to the receptor inlet 150. Correspondingly, the one or more EMR outlets 156, for example one or more 156A, one or more 156B, or both one or more 156A and 156B EMT outlets, are optically coupled to the receptor inlet 150 and the detector 106 and function to receive the scattered EMR that is reflected or scattered by the sample 170 and direct the scattered EMR to the detector 106. The one or more EMR inlets 154 and EMR outlets 156 may be comprised of an aperture or optical fiber penetrating the interior of the receptor inlet 150 and may be positioned at multiple locations throughout the receptor inlet 150.

Sample measurements that involve using both transmission and reflectance EMR may be obtained using two or more spectrometers (107) each operatively communicating with output path 156A and 156B to enable a sequential or simultaneous absorption and reflectance measurement, or a single spectrometer may be used in operative communication with two or more fibre bundles 156A and 156B, each receiving either transmitted or reflected EMR after interaction with the sample.

The sample sensor 158 (sample monitoring FIGS. 1C and 1D) detects whether the sample 170 is presented to the receptor inlet 150 in a predefined manner. For example, the sample sensor 158 may detect whether the sample 170 has been presented to the receptor inlet 150 in a manner that blocks out ambient light from entering the receptor inlet 150 or reduces the amount of ambient light entering the receptor inlet 150 below a predetermined threshold. Alternatively, the sample sensor or sample monitor 158 may detect the orientation and position of the sample with respect to the receptor inlet 150 or the depth of insertion of the sample 170 into the receptor inlet 150. The sample sensor 158 may comprise one or more optical, resistive, capacitive, pressure, electromechanical or other sensors that are positioned in or around the receptor inlet 150 to ensure that the sample 170 is presented to the receptor inlet 150 in a predefined manner. The sample sensor 158 is in communication with the processor 114 to communicate information respecting the presentation of the sample 170 to the receptor inlet 150.

The sample guide 152 aids in directing the sample 170 to be presented to the receptor inlet 150 in a predefined manner. The sample guide 152 may comprise a channel in the surface or extending from the exterior surface of the apparatus 100 leading to the receptor 104. In the alternative, the sample guide 152 may comprise an opening within which the sample may be placed or inserted.

The detector 106, which may be housed within spectrophotometer 107 is responsible for detecting the presence and intensity of various wavelengths contained in the scattered EMR. The detector 106, or spectrophotometer 107, is in communication with the processor 114, for example via a spectrophotometer interface 109, to communicate information respecting the scattered EMR detected by the detector 106. The detector 106 comprises a photodetector, such as, one or more photodiodes, charge-coupled device (CCD), photoresistors, or other devices for detecting the presence and intensity of EMR as known in the art. The photodetector may comprise a linear array detecting elements, for example, a photodiode array comprises a series of diodes that are electronically scanned to measure the charge accumulated on each diode, the charge being proportion to the intensity of scattered EMR for each wavelength transmitted through, or reflected from, one or more compounds in the sample. In the alternative, the detector 106 may further comprise a diffraction grating, or one or more filters configured to separate EMR into various wavelengths prior to directing the scattered EMR to the photodetector. In the further alternative, the detector 106 may comprise one or more lenses for concentrating, aligning or conditioning the scattered EMR prior to directing the EMR to the photodetector and/or the spectrograph or filters, for example, a diffraction grating, a collimator or a scanning focusing lens.

The detector 106 may comprise a one or two dimensional photodiode array. Such an array may comprise discrete units, or ‘pixels’, for example, which is not to be considered limiting, comprising silicon photodetectors, with single-layer thin films. Each of the thin films has a known absorption coefficient, and the absorption coefficient may be different for each of the filters. One pixel, configured to receive a specific wavelength of the scattered EMR may also be used. Scattered EMR passes through the filter to reach the photodetector, generating a signal, which is transmitted to a microprocessor. Methods for making such photodetectors are described in, for example, U.S. Pat. No. 7,345,764 to Bulovic et al. (which is incorporated herein by reference)

The detector 106 may comprise, or is in operative communication with, processor 114 or microcomputer 115 via a spectrophotometer interface 109. The processor 114, or microcomputer 115 comprising a processor, is configured to execute one or more sample processing algorithms for determining the information about the sample, for example, the information may comprise an identity, a concentration or a combination of an identity and a concentration of one or more analytes in the sample. Sample processing algorithms may comprise one or more than one calibration algorithms (for example, as disclosed in U.S. Pat. No. 6,651,015; which is incorporated by reference) that may be used to determine a property of one or more than one compound or analytes in the sample. The concentration of a given compound may be calculated by using a calibration equation derived from a statistical analysis, e.g. least squares best fit, of a plot of the value of concentration of a calibration set of samples of the compound (determined using known methods, for example U.S. Pat. No. 6,651,015, which is incorporated by reference). Other statistical tests that may be used include, but are not limited to, multiple linear regression, partial least squares or the like). Any known method for determining the concentration of one, or more than one compound may be used, as would be known to one of skill in the art. Alternately, the percent value of the one or more than one compounds may be determined from a calibration table comprising predetermined values. Such calibration tables may be prepared using a range of given absorption (or transmission) values, and related to compositions comprising a known percentage of the compound, so that the absorption (or transmission) reading is related to a known percentage of the compound, thus removing the need for mathematical manipulation. The algorithms may be preloaded in the detector or dynamically updated through communication with a remote system.

The detector 106, processor 114 or microcomputer 115 comprising a processor, may further comprises a memory for (a) storing information respecting the scattered EMR detected by the detector 106 and (b) storing instructions and statements that when executed by the processor execute one or more sample processing algorithms as described above. In the alternative, the processor 114 may provide the functionality of the processor of the detector 106 and/or the memory 110 may provide the functionality of the memory of the detector 106.

The user interface (UI) 108 is responsible for receiving instructions from a user of the apparatus 100 and communicating information to a user of the apparatus 100. For example, apparatus 100 may be in operative communication with a remote computer or cell phone via communication pathway 175 (e.g. FIG. 1F), and the user interface may be remote and comprise a PC interface 113, or a cell phone 160. Alternatively, the user interface 108 may be integral with or a part of apparatus 100, for example apparatus 100 may comprise a cell phone 160. The user interface 108 is in communication with the processor 114, or microcomputer 115, to communicate information to and from the user of the apparatus 100. The user interface 108 may receive input from a user through one or more, keypads, buttons, touch-screens, or other input devices for receiving information from a user. The input may comprise the status of the detection, instructions to initiate the detection of analytes in a sample, instructions to communicate information relating to the sample to a remote system, or other information relevant to the apparatus 100 and detection of analytes in samples. The user interface 108 may communicate information to a user through one or more displays, speakers, lights or other devices capable of presenting visual and/or audible information to a user. The information may comprise whether the sample has been presented to the receptor 104 in a predefined manner, the information detected from the sample, the status of the power source 116, or other information relevant to the apparatus 100 and detection of analytes in samples.

The communications unit 112 is in communication with the processor 114, or microcomputer 115, and is responsible for wireless communication (via 175) with one or more remote systems, for example a PC interface 113 or a cell phone 160. The communications unit 112 may comprise one or more wireless communication devices know in the art, such as, for example, cellular, bluetooth, infrared, satellite, shortwave radio or it may comprise ports permitting communication via USB, Firewire, or Ethernet.

The power source 116 is responsible for providing electrical power to the components of the apparatus 100. The power source 116 may comprise one or more batteries 117, solar cells, fuel cells, and other electrical power sources known in the art.

The memory 110, which may be included with microcomputer 115, is responsible for (a) storing information respecting the samples and (b) storing statements and instructions for execution by the processor 114 to perform the analyte detection method described below. The memory 110 may comprise random access memory, flash memory, read only memory, hard disc drives, optical drives and optical drive media, flash drives, and other computer readable storage media known in the art.

The processor 114 is responsible for controlling and communicating with the components of the apparatus 100 in order to determine analytes in one or more samples (e.g. 170) presented to the apparatus 100 via receptor 104, or spectrophotometer 107, and communicate information respecting the samples to the user of the apparatus and, optionally, remote systems. The processor 114 is responsible for performing the analyte detection method described herein. The processor 114 may comprise application specific circuits, programmable logic controllers, field programmable gate arrays, microcontrollers, microprocessors, electronic circuits and other processing devices known in the art.

Referring to FIG. 2 an apparatus for detecting analytes in a sample is generally shown as item 200. The apparatus 200 (also see 104, FIG. 1F) is operable to work in cooperation with a mobile device 250 (160, FIG. 1F) to provide similar functionality as apparatus 100 as described above (see FIGS. 1A-1D). The apparatus 200 (or 104, FIG. 1F) is capable of receiving one or more samples, detecting if the sample is presented in a predefined manner, as described above (e.g. FIGS. 1A-1F, and FIG. 1B), communicating with the mobile apparatus 250 (160 FIG. 1F) information respecting each sample, and, optionally, communicating information respecting the sample to the user of the apparatus 200 via communication pathway 220 (175, FIG. 1F) for example cellular, bluetooth, infrared, satellite, shortwave radio, USB, Firewire, or Ethernet. The mobile apparatus 250 is responsible for detecting one or more analytes in a sample from the information respecting the sample received from the apparatus 200, communicating information respecting the sample to the user of the mobile apparatus 250, and, optionally, communicating information respecting the sample to one or more remote systems, for example but not limited to, a remote computer in a doctor's office. Thus, in this example, the apparatus 200 is responsible for receiving and obtaining information respecting the samples, while, the mobile apparatus 250 is responsible for analyzing the information to identify one or more analytes in the sample, and communicating the information to the user of the mobile apparatus and, optionally, to one or more remote systems.

The apparatus 200 generally comprises an electromagnetic radiation (EMR) source 202, a receptor 204, a detector 206, a communications unit 212, and a power source 216. The apparatus 200 may optionally comprise one or more of a user interface (UI) 208, a memory 210, and a processor 214. The EMR source 202, receptor 204, detector 206 and power source 216 may be the same as, or analogous to, the EMR source 102, receptor 104, detector 106, and power source 116, respectively, as described above with respect to apparatus 100, except that the power source 216 may optionally receive power through an electrical coupling with the mobile apparatus 250. The communications unit 212 is in communication with the EMR source 202, the receptor 204, and the detector 206, and the communications unit 212 is responsible for communicating information respecting the sample between the apparatus 200 and the mobile apparatus 250 via communication pathway 220. For example, which is not to be considered limiting, the communications unit 212 may communicate with the EMR source 202 regarding control information received from the mobile apparatus 250, the communications unit may communicate to the mobile apparatus 250 information from the receptor 204 respecting the presentation of a sample to the receptor 204, the communications unit may also communicate to the mobile apparatus 250 information respecting the sample received from the detector 206. The communications unit 212 may comprise any wired or wireless communication device known in the art, such as, for example but not limited to, USB, Firewire, Ethernet, Bluetooth, and infrared for communication with mobile apparatus 250 and the like, via communications pathway 220.

The mobile apparatus 250 generally comprises a communications unit 252, a processor 254, a user interface 256, a memory 258, and a power source 260. For example, communications unit 252, processor 254, user interface 256, memory 258, and power source 260, may be the same as, or analogous, to communications unit 112, processor 114, user interface 108, memory 110, and power source 116, respectively, as described above with respect to apparatus 100, except as noted otherwise. In particular, communications unit 252 is also configured to communicate with apparatus 200 and processor 254 is configured to communicate with EMR source 202, receptor 204, detector 206 of apparatus 200 through the communications unit 252 and communication pathway 220. The communications unit 252 may comprise any wired or wireless communication device known in the art, such as, for example, USB, firewire, Ethernet, Bluetooth, and infrared and the like.

Alternatively, the apparatus 200 further comprises a processor 214 and a memory 210. In this example, the processor 214 is responsible for communicating with the EMR source 202, the receptor 204, the detector 206, and the communications unit 212, while, the communications unit 212 is responsible for communicating with the mobile apparatus 250. Further, the processor 214 assumes the responsibility of the processor 254 of the mobile apparatus 250 with respect to detecting one or more analytes in the samples based on the information received from the detector 206. The memory 210 also assumes the responsibility of the memory 258 with respect to storing instructions and statements that when executed by the processor 214 performs one or more sample processing algorithms of the scattered EMR, and, optionally, storing information respecting the scattered EMR detected by the detector 206. Thus, in this example, the apparatus 200 is responsible for receiving and obtaining information respecting the samples and analyzing the information to identify one or more analytes in the sample, while, the mobile apparatus 250 is responsible for communicating the information to the user of the mobile apparatus and/or a remote system.

The apparatus 200 may further comprise a user interface 208. The user interface 208 provides similar functionality to the user interface 108 of apparatus 100 described above, except as noted otherwise. The user interface 208 may receive input from a user, for example, instructions to initiate the detection of analytes in a sample. The user interface 208 may also communicate information to a user, for example, the status of the detection, whether the sample has been presented to the receptor 204 in a predefined manner, the information detected from the sample, or the status of the power source 216.

As described above, apparatuses 100 and 200 comprise receptors 104, 204 or a finger module, that are responsible for, amongst other things, detecting whether the sample is presented to the receptor 104, 204 in a predefined manner. In order to increase the reliability and accuracy of the detection of analytes in a sample, it may be desirable to ensure that the sample is presented to the receptor 104, or 204 in a manner that reduces the amount of ambient light that is permitted to entering the receptor inlet 150 of the receptors 104, 204 below a predefined threshold, or to ensure proper alignment between the sample and the incident (156) and scattered (transmitted or reflected; 156) light paths. One or more sample sensors (or sample monitors) 158 may be placed at appropriate locations in and/or about the receptor inlet 150 and these can be used to detect whether a sample has been presented to the receptor inlet 150 in a manner that will ensure proper alignment and minimize the amount of ambient light that is permitted to enter the receptor inlet 150. Sample sensors 158 may be used to directly detect the amount of ambient light in the receptor inlet 150 or detect whether the sample is in a location and/or orientation that is known to ensure proper alignment or minimize the amount ambient light entering the receptor inlet 150.

Referring to FIGS. 3A and 3B, an example of the receptor 104 is shown as item 104A. The receptor 104A is configured to directly detect the amount of ambient light in the receptor inlet through one or more optical sensors placed inside of the receptor 104A. The receptor 104A generally comprises a receptor inlet 150A and a sample sensor 158A, identical in function to receptor inlet 150 and sample sensor 158 described above. The receptor inlet 150A comprises an aperture configured to accept a sample or sample holder positioned over the aperture. The sample sensor 158A may comprise one or more optical sensors 304 located inside of the receptor inlet 150A. For example, the sensors 304 may be placed at the bottom of the receptor inlet 150A, around the perimeter of the inner surface of the receptor inlet 150A, adjacent to the EMR outlets of the receptor 104A, in close proximity to the outer surface of the receptor 104A, and other locations inside of the receptor inlet 150A.

The sensors 304 may comprise a photodiode, photoresistor, phototransistor, or any optical sensor capable of detecting ambient light known in the art. Optionally, each sensor 304 may be electrically coupled to a separate or shared conditioning unit 306. The conditioning unit 306 is in operative communication with processor 114, microcomputer 115 or communications unit 212, and functions to place the output of the sample sensor 158A in a desired form prior to directing the output to the processor 114 or microcomputer 115 of apparatus 100 or the communications unit 212 of processor 214 of apparatus 200. For example, the conditioning unit 306 may amplify, demodulate, offset, filter undesirable frequencies, convert from analog to digital, or compare the output to a predefined threshold. Furthermore, if an error is observed with respect to the sample interfacing the receptor, the conditioning unit 306 may trigger a warning signal, light, alarm and the like in order to notify the user of the problem.

The receptor 104A may be configured to receive in vivo samples, or in vitro sample holders containing samples, or both.

Referring to FIGS. 3C to 3F, the receptor 104A is shown having an in vivo sample 170A presented to the receptor 104A in the form of a human finger (FIGS. 3C and 3D) and an in vitro sample holder 170B presented to the receptor 104A (FIGS. 3E and 3F) in the form further described below with reference to FIG. 7C. FIGS. 3C and 3E show improper presentations of the in vivo sample 170A and the in vitro sample holder 170B to the receptor 104A, resulting in ambient light 350 entering the receptor inlet 150A and being detected by the sensor 304. By contrast, FIGS. 3D and 3F show proper presentations of the in vivo sample 170A and the in vitro sample holder 170B to the receptor 104A, resulting in no, or minimal, ambient light 350 being detected by the sensor 304.

Referring to FIG. 7C, a non limiting example of an in vitro sample holder 170B is provided. Other non limiting examples of sample holders that may also be used with the receptor/apparatus of the present invention are described in U.S. 61/370,687 (filed Aug. 4, 2010), CA 2,460,898, U.S. Pat. No. 5,800,781, WO 00/70350 (each of which is incorporated herein by reference).

In this example, sample holder 170B may generally comprise a body 772, a gripping portion 773 for ease of handling, one or more sample wells 774, a sample input port 775, conduits 776, and, optionally, one or more overflows/vents 777. The sample may be loaded by injection into the sample input port 775, for example, from a syringe, with a pipette or similar device for transferring small liquid volumes, or by capillary action. The one or more sample wells 774 are in fluid communication with the sample input port 775 and each other through conduits 776. Optionally, one or more overflows/vents 777 permit air to escape the wells 774 and conduits 776 as they are filled with the sample. The ‘windows’ covering the one or more sample wells 774 of the sample holder 170B, comprise material that is EMR-transparent in order to permit EMR to pass into the sample well and irradiate the sample. For example, for near-infrared EMR, SiO₂ may be used for sample chamber windows, while for ultraviolet EMR, ultraviolet-transparent material may be used for sample chamber windows. For visible light EMR, glass may be suitable. Selection of a suitable material will be within the ability of one skilled in the art, upon consideration of the appropriate EMR wavelength(s) to be used.

An non-limiting example of a multi-sample well sample holder is described in PCT Application PCT/CA2011/050475 (“Method and Apparatus for Analyte Detection”: which is herein incorporated by reference) and shown in FIG. 7D. Briefly, multi-sample well sample holder 170E comprises similar components to sample holder 170B, but includes a plurality of sample wells 774′ in fluid communication with a single sample input port 775. For example, the multi-sample well sample holder may comprise from 1 to 50, or more, sample wells 774′, or any amount therebetween, for example 1, 2, 3, 4, 5, 6, 7, 8, 9, 10, 12, 14, 16, 18, 20, 22, 24, 26, 28, 30, 32, 24, 26, 28, 40, 42, 44, 46, 48, 50 sample wells, or any number therebetween. The apparatus may be configured such that, when the multi-sample well sample holder 170E is inserted within the receptor 104, each sample well 774′ is positioned to be exposed to one or more select EMR wavelength(s) as required to determine an analyte of interest within the specific sample well 774′.

The apparatus or device of the present invention may therefore be configured to pass EMR wavelengths through each of the 1 to 50 or more sample wells 774′ or any number therebetween. The apparatus may be configured to introduce either the same wavelength of EMR to each of the 1 to 50 or more sample wells 774′, or from 1 to 50 or more different wavelengths of EMR through each of the 1 to 50 or more sample wells 774′, or any number therebetween. For example, 1, 2, 3, 4, 5, 6, 7, 8, 9, 10, 12, 14, 16, 18, 20, 22, 24, 26, 28, 30, 32, 24, 26, 28, 40, 42, 44, 46, 48, 50 or any number therebetween of different wavelengths may be used. Alternatively, a spectrum of wavelengths may be passed through each of the one or more sample wells, for example as described in U.S. Pat. No. 6,611,777; U.S. Pat. No. 6,651,015; U.S. Pat. No. 7,157,282; or WO 2007/028231 (which are incorporated herein by reference) and the spectrum analyzed for one or more target analytes that may be present within each sample well.

With each of the configurations described above, multiple analytes within a sample may be identified and additional information about the analyte determined. With sample holder 170E, comprising a plurality of sample wells 774′, one sample may be used and portions of the sample, located in each sample well 774′ may be subject to one or more, or different EMR wavelengths for the determination of different analytes within the sample.

An alternate sample holder, a multi-sample port sample holder 170F, is shown in FIG. 7E. In this example, the multi-sample port sample holder 170F may generally comprise a body 772, a gripping portion 773 for ease of handling, a plurality of sample wells 774′, a plurality of sample input ports 775′, conduits 776 and, optionally, one or more overflows/vents 777. These components are identical in function to the components described above with respect to in vitro sample holders 170B and 170E. The multi-sample port sample holder 170F, however, comprises a plurality of sample input ports 775′ for receiving one or more samples for analysis, as well as a plurality of sample wells 774′. One or more samples may be loaded by injection into the one or more sample input ports 775′. Each sample input port 775′ is in fluid communication with one or more samples wells 774′. All the sample wells 774′ that are in fluid communication with a specific sample input port 775′ are in fluid communication with each other through conduits 776. With this configuration, sample wells 774′ in fluid communication with one sample input port 775′ will not be in fluid communication with sample wells 774′ in fluid communication with a different sample input port 775′ in order to prevent cross-contamination of the various samples. This configuration permits the analysis of various samples, such as, but not limited to, blood, saliva and urine, at one time. As with the multi-sample well sample holders, the apparatus may be configured such that, when the multi-sample port sample holder 170F is inserted within the receptor 104, the various samples within the sample wells 774′ can be exposed to one or more select EMR wavelength(s) as required to determine an analyte of interest in a specific sample. The apparatus may be configured to introduce either the same wavelength of EMR to the different samples in the sample wells 774′, or from 1 to 50 more different wavelengths of EMR to the different samples in each of the 1 to 50 or more sample wells 774′, or any number therebetween. Alternatively, a spectrum of wavelengths may be passed through each of the one or more sample wells, for example as described in U.S. Pat. No. 6,611,777; U.S. Pat. No. 6,651,015; U.S. Pat. No. 7,157,282; or WO 2007/028231 (which are incorporated herein by reference) and the spectrum analyzed for one or more target analytes that may be present within each sample well. With each of these configurations, multiple analytes within multiple samples may be identified and additional information about the analytes determined.

By placing the multi-sample well sample holder 170E or the multi-sample port sample holder 170F within a receptor 104, and by ensuring that specific wavelengths of EMR are directed to specific sample wells 774′, one or more wavelengths of EMR may be selected and used for determination of an analyte within the one or more samples. For example, the receptor 104 may be configured to detect the type of sample holder inserted in the receptor 104 such that a pre-set one or more wavelengths of EMR is selected and used to determine the identity/concentration of one or more analytes in the one or more samples within the one or more sample wells 774′. These in vitro sample holders can also be useful for verifying and confirming data if the same wavelength of EMR is selected and used to pass through the same sample in different sample wells 774′. The identity or concentration of the one or more analytes in the sample can then be compared amongst the different sample wells 774′.

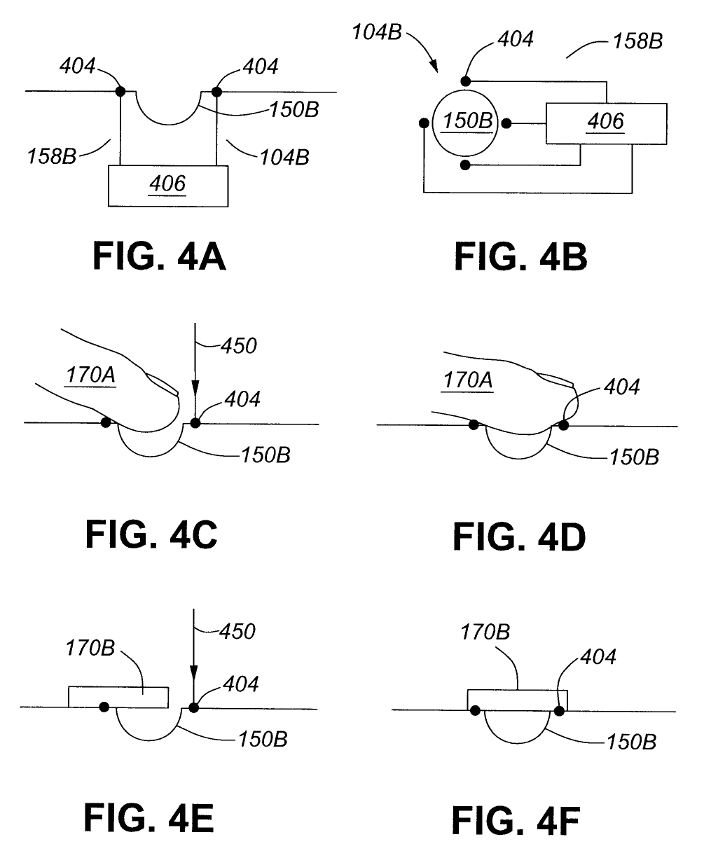

Referring to FIGS. 4A and 4B, an alternate example of the receptor 104 is shown as item 104B. The receptor 104B is configured to detect whether a sample or sample holder is in a location and/or orientation that is known to minimize the amount ambient light entering the receptor inlet or ensure proper alignment of the sample with the receptor. The receptor 104B generally comprises a receptor inlet 150B and a sample sensor 158B, similar in function to receptor inlet 150 and sample sensor 158 described above. The receptor inlet 150B comprises an aperture configured to accept a sample or sample holder positioned over the aperture. The sample sensor 158B may comprise one or more sensors 404 located outside of and directly adjacent to the entrance of the receptor inlet 150B. For example, the sensors 404 may be placed at spaced intervals around the outer perimeter of the entrance of the receptor inlet 150B, at spaced concentric intervals radiating from the outer perimeter of the entrance of the receptor inlet 150B, and other locations in close proximity to the entrance of the receptor inlet 150B.

The sensors 404 may comprise any sensor capable of detecting the presence of a sample or sample holder, for example: contactless sensors, such as, optical sensors (e.g. photodiodes, photoresistors, or phototransistors), capacitive proximity sensors, thermal sensors (e.g. thermocouple or thermistor), acoustic sensors (e.g. ultrasonic sensors); and contact sensors, such as, resistive sensors, capacitive touch sensors, piezoelectric sensors, pressure sensors, or electromechanical switches (e.g. membrane switch). Optionally, each sensor 404 is electrically coupled to a separate or shared conditioning unit 406. The conditioning unit 406 functions to place the output of the sample sensor 158B in a desired form prior to directing the output to the processor 114 of apparatus 100 or the communications unit 212 or processor 214 of apparatus 200. For example, the conditioning unit 406 may amplify, demodulate, offset, filter undesirable frequencies, convert from analog to digital, or compare the output to a predefined threshold. Furthermore, if an error is observed with respect to the sample interfacing the receptor, the conditioning unit 406 may trigger a warning signal, light, alarm and the like in order to notify the user of the problem.

The receptor 104B may be configured to receive in vivo samples, or in vitro sample holders containing samples, or both.

Referring to, FIGS. 4C to 4F, the receptor 104B is shown having an in vivo sample 170A presented to the receptor 104B in the form of a human finger (FIGS. 4C and 4D) and an in vitro sample holder 170B presented to the receptor 104B (FIGS. 4E and 4F) in the form described above with reference to FIG. 7C. FIGS. 4C and 4E show improper presentations of the samples 170A and sample holders 170B to the receptor 104B, resulting in failure of the in vivo sample 170A or the in vitro sample holder 170B to be detected by all of the sensors 404 about the receptor inlet 150B, indicating that the in vivo sample 170A or the in vitro sample holder 170D has not completely covered the entrance to the inlet 150B. By contrast, FIGS. 4D and 4F show proper presentations of the in vivo sample 170A and the in vitro sample holders 170B to the receptor 104B resulting in the detection of the in vivo sample 170A and the in vitro sample holders 170B by all of the sensors 404 about the receptor inlet 150B, indicating that the in vivo sample 170A or the in vitro sample holder 170D has completely covered the entrance to the inlet 150B.

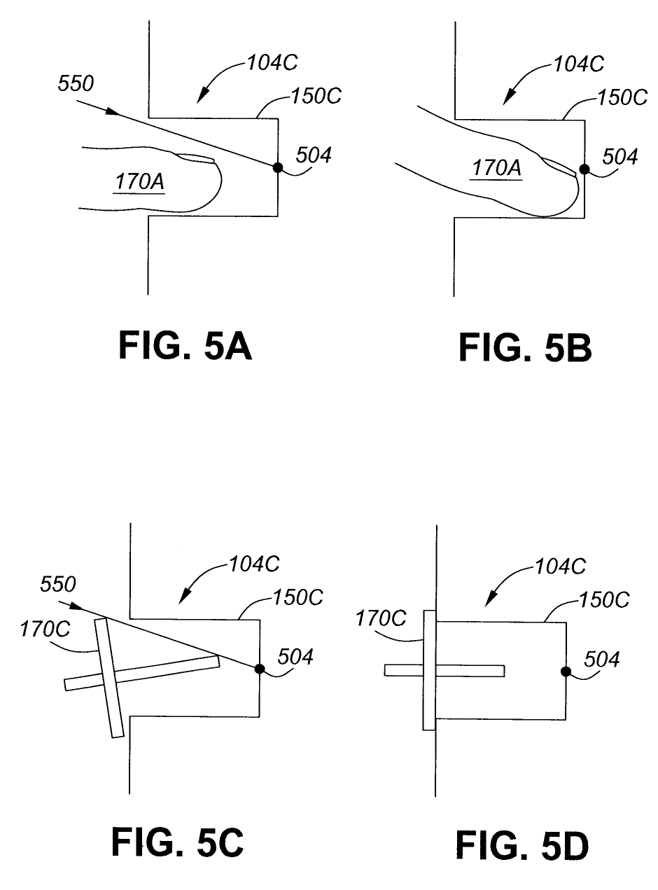

Referring to FIGS. 5A to 5D, a further example of the receptor 104 is provided. In this example, receptor 104C is configured to directly detect the amount of ambient light in the receptor inlet through one or more optical sensors placed inside of the receptor 104C. The receptor 104C generally comprises a receptor inlet 150C and a sample sensor, similar in function to receptor inlet 150 and sample sensor 158 described above. The receptor inlet 150C comprises an aperture configured to accept an in vivo sample or an in vitro sample holder inserted inside of the aperture. The sample sensor may comprise one or more optical sensors 504 located inside of the receptor inlet 150C. For example, the sensors 504 may be placed at the bottom of the receptor inlet 150C, around the perimeter of the inner surface of the receptor inlet 150C, adjacent to the EMR outlets of the receptor 104C, in close proximity to the outer surface of the receptor 104C, and other locations inside of the receptor inlet 150C.

The sensors 504 may have the same features and optionally be electrically coupled to one or more conditioning units in the same manner as described above for sensors 304 of receptor 104A. The receptor 104A may be configured to receive in vivo samples, in vitro sample holders containing samples, or both. Referring to FIGS. 5A to 5D, the receptor 104C is shown having an in vivo sample 170A presented to the receptor 104C in the form of a human finger (FIGS. 5A and 5B) and an in vitro sample 170C presented to the receptor 104C (FIGS. 5C and 5D) in the form further described below with reference to FIG. 7A. FIGS. 5A and 5C show improper presentations of the in vivo sample 170A and the in vitro sample holder 170C to the receptor 104C, resulting in failure of the in vivo sample 170A and the in vitro sample holder 170C to be properly detected by one or more of the sensors 504 about the receptor inlet 150C, indicating that the in vivo sample 170A or the in vitro sample holder 170C has not completely covered the entrance to the inlet 150C, or that the in vivo sample or the in vitro sample holder is not in proper alignment within the receptor. By contrast, FIGS. 5B and 5D show proper presentations of the in vivo sample 170A and the in vitro sample holder 170C to the receptor 104C resulting in the detection of the in vivo sample 170A and the in vitro sample holder 170C by one or more of the sensors 504 about the receptor inlet 150C, indicating that the in vivo sample 170A or the in vitro sample holder 170C has completely covered the entrance to the inlet 150C.

Referring to FIG. 7A, an in vitro sample holder 170C is shown. Other non limiting examples of sample holders that may configured and used with the receptor/apparatus of the present invention are described in U.S. 61/370,687 (filed Aug. 4, 2010), CA 2,460,898, U.S. Pat. No. 5,800,781, WO 00/70350 (each of which is incorporated herein by reference).

In this example, sample holder 170C generally comprises a body 702, a gripping portion 703 for ease of handling, one or more sample wells 704, a sample input port 705, conduits 706, and, optionally, one or more overflows/vents 707. These components are identical in function to body 772, gripping portion 773, sample wells 774, sample input port 775, conduits 776, and overflows/vents 777, respectively, as described above with respect to in vitro sample holder 170B. In addition, sample holder 170C further comprises a flange 709 extending from the body 702. The flange 709 provides a surface that is configured to interface with the outside surface of the receptor 104C to prevent ambient light from entering the receptor inlet 150C. The flange 709 maybe comprised of one or more materials that will not pass ambient light.

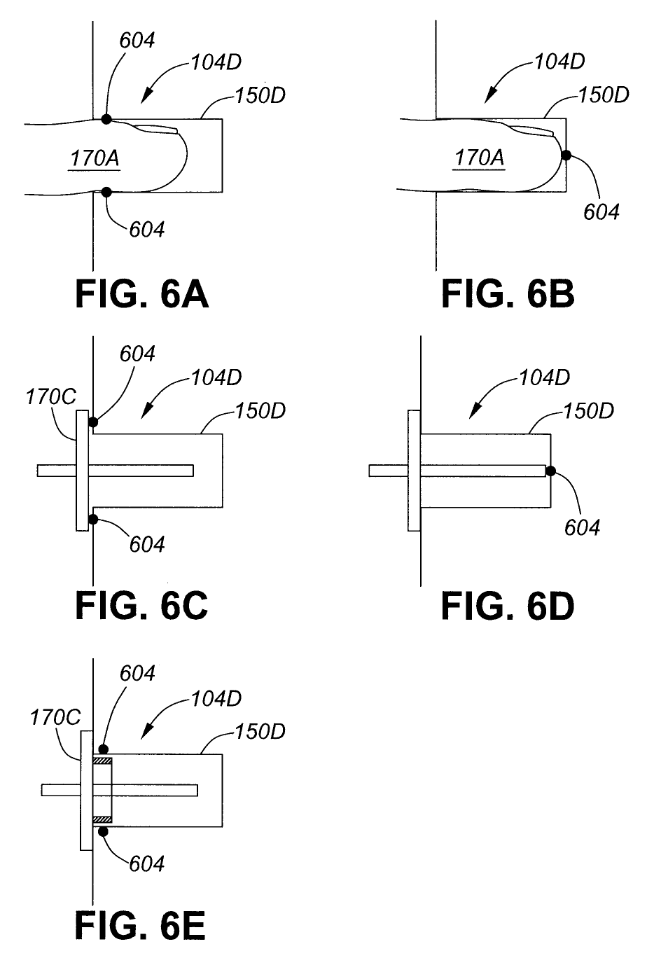

Referring to FIGS. 6A to 6E, an alternate example of the receptor 104 is shown as item 104D. The receptor 104D is configured to detect whether a sample or sample holder is in a location and/or orientation that is known to minimize the amount ambient light entering the receptor inlet. The receptor 104D generally comprises a receptor inlet 150D and a sample sensor, similar in function to receptor inlet 150 and sample sensor 158 described above. The receptor inlet 150D comprises an aperture configured to accept a sample or sample holder inserted inside of the aperture. The sample sensor may comprise one or more sensors 604 located outside of or inside of the receptor inlet 150D configured to detect the presence of a sample or sample holder. The sensors 604 may have the same features and optionally be electrically coupled to one or more conditioning units in the same manner as described above for sensors 404 of receptor 104B. The receptor 104D may be configured to receive in vivo samples, in vitro sample holders containing samples, or both.

Referring to FIG. 6A, the receptor 104D is shown having an in vivo sample 170A presented to the receptor 104D in the form of for example, a human finger. The sensor 604 detects whether the in vivo sample 170A is inserted into the inlet 150D in a manner that causes the in vivo sample 170A to form a seal with the inlet 150D, by directly detecting the seal through the placement of sensors 604 around the perimeter of the inner surface of the inlet 150D near the entrance of the inlet 150D where the seal is expected to be made.

Referring to FIG. 6B, the receptor 104D is shown having an in vivo sample 170A presented to the receptor 104D in the form of for example, a human finger. The sensor 604 detects whether the in vivo sample 170A is inserted into the inlet 150D in a manner that causes the sample 170A to form a seal with the inlet 150D, by indirectly detecting the seal through the placement of sensors 604 at the bottom of the inlet 150D where the tip of the in vivo sample 170A is expected to contact when a seal has been made by the sample 170A near the entrance of the inlet 150D.

Referring to FIG. 6C, the receptor 104D is shown having an in vitro sample holder 170C presented to the receptor 104D in the form describe above with reference to FIG. 7A. The sensor 604 detects whether the in vitro sample holder 170C is inserted into the inlet 150D in a manner that causes the flange 709 of the in vitro sample holder 170C to completely cover the entrance of inlet 150D, through the placement of sensors 604 located outside of and directly adjacent to the entrance of the receptor inlet 150D.

Referring to FIG. 6D, the receptor 104D is shown having an in vitro sample holder 170C presented to the receptor 104D in the form describe above with reference to FIG. 7A. The sensor 604 detects whether the in vitro sample holder 170C is inserted into the inlet 150D in a manner that causes the flange 709 of the in vitro sample holder 170C to completely cover the entrance of inlet 150D, through the placement of sensors 604 at the bottom of the inlet 150D where the tip of the in vitro sample holder 170C is expected to contact when the flange 709 of the in vitro sample holder has completely covered the entrance of the inlet 150D.

Referring to FIG. 6E, the receptor 104D is shown having an in vitro sample holder 170D presented to the receptor 104D. Referring to FIG. 7B, in vitro sample holder 170D generally comprises a body 752, a gripping portion 753 for ease of handling, one or more sample wells 754, a sample input port 755, conduits 756, a flange 759, and, optionally, one or more overflows/vents 757. These components are identical in function to body 702, gripping portion 703, sample wells 704, sample input port 705, conduits 706, flange 709 and overflows/vents 707, respectively, as described above with respect to in vitro sample holder 170C. In addition, sample holder 170D further comprises a plug 758 extending from the body 752 and the flange 759. The plug 758 is shaped and sized to form a seal around the perimeter of the inner surface of the inlet 150D near the entrance of the inlet 150D when inserted into the inlet 150D. The plug 758 may be comprised of one or more materials that will not pass ambient light.

Sensor 604 (FIG. 6E) detects whether the in vitro sample holder 170D is inserted into the inlet 150D in a manner that causes the plug 758 of the in vitro sample holder 170D to form a seal with the inner surface of the inlet 150D, by directly detecting the seal through the placement of sensors 604 around the perimeter of the inner surface of the inlet 150D near the entrance of the inlet 150D where the seal is expected to be made.

Referring to FIGS. 8A to 8D, another example of the receptor 104 (104E) is shown. The receptor 104E generally comprises a receptor inlet 150E and a sample sensor, identical in function to receptor inlet 150 and sample sensor 158 described above. The receptor inlet 150E comprises an aperture configured to accept a sample holder inserted inside of the aperture. In addition, the receptor 104E comprises covers 810A, 810B made of a material that does not pass ambient light. The covers 810A, 810B may be placed in an open state, permitting a sample holder to be inserted into the inlet 150E, and a closed state, containing the sample holder inside of the inlet 150E and preventing ambient light from entering the inlet 150E. The receptor 104E may also comprise a sample holder retainer 814 for retaining the sample holder in place when inserted into the inlet 150E. The retainer 814 may comprise one or more flexible or retractable members, or guides that function to retain the sample holder in place.

Referring to FIGS. 8A and 8B, the sample sensor comprises one or more optical sensors 804A located inside of the inlet 150E and configured to directly detect the amount of ambient light in the receptor inlet 150E. The sensors 804A may have the same features and optionally be electrically coupled to one or more conditioning units in the same manner as described above for sensors 304 of receptor 104A. In FIG. 8A, the cover 810A may be received in or extended out of an internal pocket 808 to reveal or cover the inlet 150E. In FIG. 8B, the cover 810B may be moved away from or over the entrance of the inlet 150E to reveal or cover the inlet 150E.

Referring to FIGS. 8C and 8D, the sample sensor comprises one or more sensors 804A configured to detect the whether the covers 810A, 810B are in an open or closed state. The sensors 804A may have the same features and optionally be electrically coupled to one or more conditioning units in the same manner as described above for sensors 404 of receptor 104B. The cover 810A and 810B operate in the same manner described above with reference to FIGS. 8A and 8B.

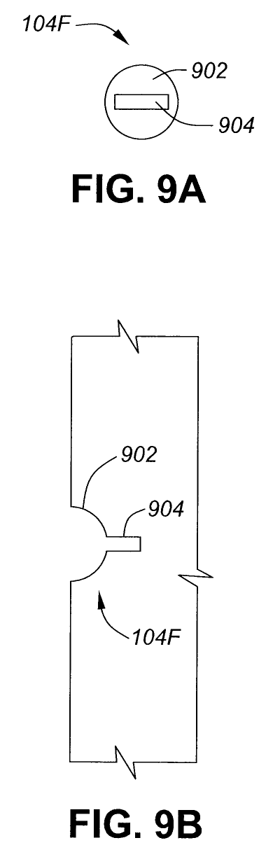

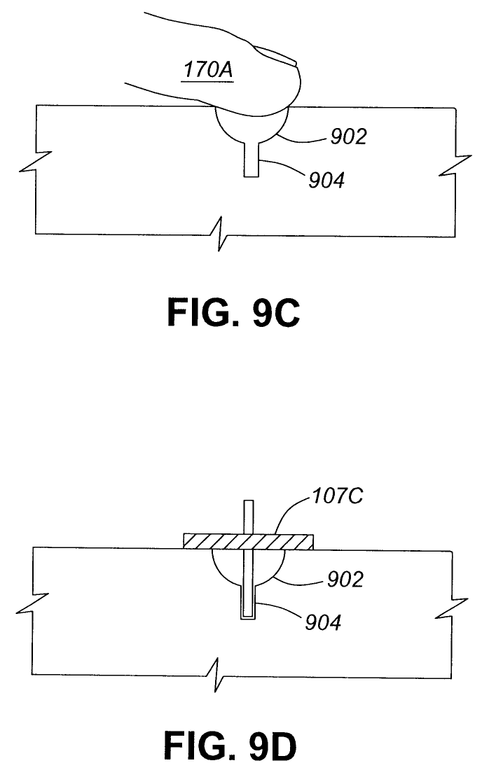

Referring to FIGS. 9A to 9D, an example of receptor 104 is shown as item 104F. The receptor 104F generally comprises a sample sensor, a first receptor inlet 902, and a second receptor inlet 904. The first receptor inlet 902 is an aperture configured to accept an in vivo sample over the aperture. The second receptor inlet 904 is located within the first receptor inlet 902 and comprises an aperture configured to accept an in vitro sample holder inserted inside of the aperture. The sample sensors may comprise one or more of the sensors described in respect any of the foregoing embodiments of the receptor. FIG. 9C shows an exemplary presentation of sample 170A to the receptor 104F, while FIG. 9D shows an exemplary presentation of sample 170B to the receptor 104F.

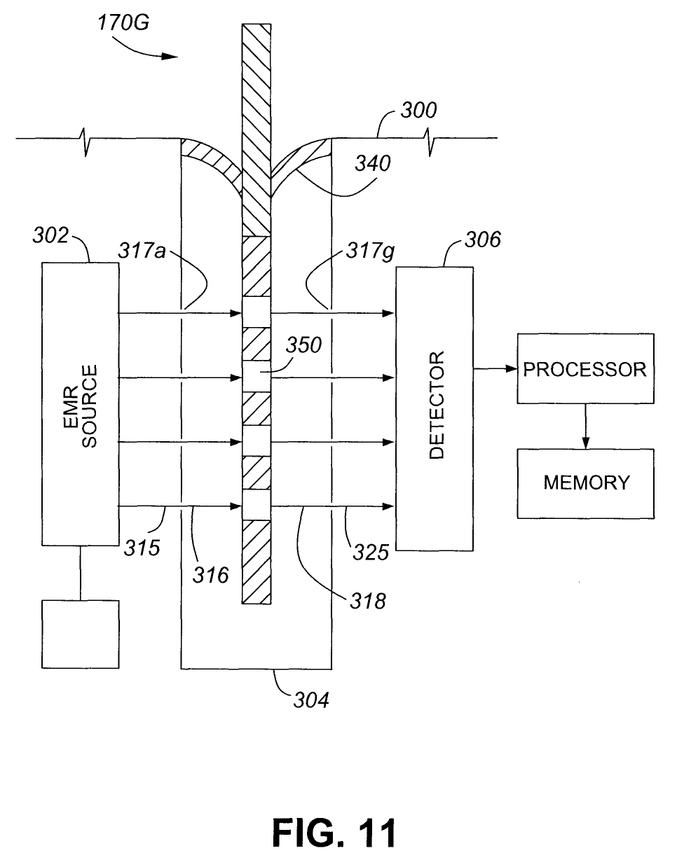

An alternate device for analyzing multiple samples at a time is described in PCT/CA2011/050475 (“Method and Apparatus for Analyte Detection”; incorporated herein by reference) and shown in FIG. 11. In this example, the device 300 comprises a multiport sample holder 170G inserted in the receptor 304, in addition to the other components described for device 100 and device 200. The multiport sample holder 170G comprises a plurality of sample wells 350 that are separately loaded such that each sample well may comprise different samples, such as, but not limited to, a bacterial sample, a body fluid, for example, blood, cerebrospinal fluid, urine or saliva. In this example, the source of EMR 302, the receptor 304 and the detector 306 are in an operative optical association, so that a path of EMR from the source of the EMR 302 through the receptor 304 to the detector 306 may be established. The path of the EMR through the housing is guided from the EMR source to the receptor by an optic input 315, and from the receptor to the detector by an optic output 325. Entrance of the incident EMR beam 316 to the receptor 304 is facilitated by input port 317a; similarly, exit of the reflected and/or refracted EMR beam is facilitated by output port 317g. When a multiport sample holder 170G is placed within the receptor, a plurality of wells 350 in the multiport sample holder 170G are in line with corresponding optic input 315—optic output 325 pairs. The different sample wells 350 in the multiport sample holder 170G may comprise the same or different types of samples, such as, but not limited to, a bacterial sample, a body fluid, for example, blood, cerebrospinal fluid, urine or saliva, and the same or different EMR wavelengths, or a spectrum of wavelengths, for example as described in U.S. Pat. No. 6,611,777; U.S. Pat. No. 6,651,015; U.S. Pat. No. 7,157,282; or WO 2007/028231 (which are incorporated herein by reference) may be selected and passed through these samples in the sample wells 350. For example which is not to be considered limiting in any manner, for an athletic application, there may be a need to detect and quantify morphine in saliva, one or more steroids in urine, and hemoglobin in blood, or to verify a morphine measurement in a urine sample that, was or is, also determined from a saliva sample. The resultant wavelengths of EMR that either pass through, reflect off, or both pass through and reflect off, of the sample, may then be detected and analyzed to determine the identity or concentration of analytes of interest in the different samples.

The device may optionally include flexible light shields 340 at the entrance of the receptor, to minimize interference of scattered or stray light, and/or prevent ambient light from interfering with the EMR transmission in the receptor and through the multiport sample holder 170G.

Analyte Detection Method

Referring to FIG. 10, in operation, apparatuses 100, 200, 300 perform method 1000 to detect one or more analytes in one or more samples. In step 1002, a user presents an in vivo sample, for example a finger or other body part, or an in vitro sample holder containing a sample, to the receptor 104, 204, 304 of the apparatus 100, 200, 300 and requests the detection of analytes in the one or more samples either through the user interface 108, 208, 256, or automatically after the sample holder is properly registered with the receptor.

The method 1000 proceeds to step 1004 where the processor 114, 214, 254 communicates with the receptor 104, 204, 304 to determine whether the sample or sample holder has been presented in a predefined manner that ensures that the sample is properly registered with the receptor as described above. The sample sensor 158 detects if the sample or sample holder has been presented to the receptor inlet 150 in a predefined manner, the result of which is communicated to the processor 114, 214, 254. If the sample or sample holder has been presented in a predefined manner, the method 1000 proceeds to step 1008, otherwise, the method 1000 proceeds to step 1006 and informs the user through the user interface 108, 208, 256 or by an alarm, light, or other notification method, that the sample or sample holder has not been presented in a predefined manner.

In step 1008, the processor 114, 214, 254 instructs the EMR source 102, 202, 302 to emit EMR. The EMR source 102, 202, 302 emits EMR which is delivered to the one or more samples through the EMR inlets 154, 315 of the receptor 104. The method 1000 then proceeds to step 1010 where the scattered, transmitted, or reflected EMR from the one or more samples is directed through the EMR outlets 156, 325 of the receptor 104, 304 and to the detector 106, 306.

The detector 106, 306 detects desired wavelengths and intensities in the scattered EMR and communicates this information to the processor 114, 214, 254.

The method 1000 then proceeds to step 1012 where the processor 114, 214, 254 analyses the information received from the detector 106, 306 to detect if one or more desired analytes are present in the one or more samples in the manner described above. The method 1000 then proceeds to step 1014 where the processor 114, 214, 254 communicates the analytes detected in the one or more samples to the user through the user interface 108, 208, 256. The method 1000 then, optionally, proceeds to step 1016 where the processor 114, 214, 254 communicates the analytes detected in the one or more samples to one or more remote systems through the communications unit 112, 252.

Therefore, the present invention provides an apparatus for determining one or more analytes in one or more samples, the apparatus may comprise a device that is in operative communication with a cell phone, a mobile, or other computing device. The device may comprise a receptor for receiving a sample or sample holder, in optical communication with a source of EMR, and a spectrometer, or a detector in operative communication with a processor or micro computer. The cell phone or other computing device may comprise application software for analyte monitoring, along with an appropriate user interface. The device may comprise blue tooth or other means for wireless connection, and/or a USB, Firewire or Ethernet connection for hard wire connectivity or memory-stick data transfer, to the cell phone or other computing device. The device may be physically independent from the cell phone or other computing device, or the device may be integrated within the cell phone or other computing device. The receptor may comprise a glide path or channel, molded into the device, for guiding the finger, thumb, or sample holder into proper orientation with the receptor. The receptor may comprise a warning system to notify the user whether the finger, body part, or sample holder has not properly covered over the aperture of the receptor. Data determined using the device in combination with the cell phone or other computing device regarding the one or more analytes detected within the sample may be downloaded via the interne to a computing device. The device may be configured to monitor multiple analytes within a sample using one or more spectrometers, one or more fiber optics connectors in optical communication with each of the one or more spectrophotometers, to provide light from an EMR or light source to either one or more port(s) within the receptor. If the sample is an in vivo sample, then the pulse may also be determined if desired. Furthermore, sample measurements may take place using either transmission, reflectance, or transmission and reflectance to detect a specific analyte in a sample. Obtaining both transmission and reflectance data may be obtained using two or more spectrometers each operatively communicating with output path 156 to enable a simultaneous absorption and reflectance measurement, or a single spectrometer may be used in operative communication with two or more fibre bundles each receiving either transmitted or reflected EMR after interaction with the sample. In this example, the receptor (finger interface) is configured to enable absorption and reflectance EMR to be obtained from a sample, as consecutive measurements. This combination of information provides increased accuracy of an analyte to determine for example the impact of interstitial fluid on a blood glucose prediction.

In addition, if the one or more samples are in an in vitro sample holder, electrode sensors may be used for additional blood gas or ion analysis of the one or more samples, including, but not limited to, pH, pCO₂, pO₂ and salts, for example Na⁺, K⁺. Such electrodes are well known in the art. A non-limiting example of electrode sensors is provided in U.S. Pat. No. 5,325,853 to Morris et al. (which is herein incorporated by reference). The electrode sensors may be a part of the device 100, 200, 300 or the computing device 113 or may be in operative communication with the device or computing device. The electrode sensors may therefore comprise any wired or wireless communication device known in the art, such as, for example but not limited to, USB, Firewire, Ethernet, Bluetooth, and infrared for communication with the device 100, 200, 300 or the computing device 113.

As a complement to the data obtained as described using the device of the present invention, on select analytes within the one or more samples, the devices, systems and methods described in U.S. Pat. No. 7,315,767; US 2008/0319293; US 2010/0065751; US 2010/0069731; US 2010/0072386; U.S. Pat. No. 6,723,048; U.S. Pat. No. 7,316,649; and US 2004/0193031 (all of which are herein incorporated by reference) may also be used. These systems are outlined below, and may be used in combination with the device described herein to further evaluate and measure one or more analytes in a sample well and this data may be used to confirm the results obtained using EMR.

For example, US 2008/0319293 and related publications (e.g. US 2010/0072386, US 2010/0065751; and US 2010/0069731; collectively referred to as “Looney et al.”) describe non-invasive systems and methods for scanning and analyzing characteristics of a sample using a large spectrum of electromagnetic radiation that is transmitted through a sample to a receiver to create a series of spectral data sets, which are subsequently developed into a composite spectrogram to determine characteristics of the sample. Looney et al. further describe the use of a magnetic field around the transmitter, receiver and sample to enhance certain characteristic analysis applications and to make other characteristic analysis applications possible. Such systems and methods can be used to verify the data obtained on select analytes using the devices of the present invention and for improved accuracy of the data obtained. The system described by Looney et. al. may be included within the device of the present invention so that the one or more analytes within the sample are characterized using one or more detection methods.

Alternatively, the sample holder may be measured using the devices described herein, and then inserted within a receptor of a second apparatus for further analysis, for example as described by Looney et. al.

U.S. Pat. No. 6,723,048 to Fuller and its related US applications (e.g. US 2004/0193031 and U.S. Pat. No. 7,316,649; which are incorporated herein by reference; collectively referred to as “Fuller”) may also be used to verify the data obtained on select analytes using the devices of the present invention. Fuller discloses a novel amplifier that uses the orientation and alignment of high guass permanent magnets to create a single magnetic field, within which an Rf signal is transmitted from a transmission node, through a sample and to a receiver node in order to detect and quantitate analytes, such as glucose, cholesterol, proteins such as hemoglobin or hormones, and viruses in a sample. The apparatus of Fuller may be particularly useful for example, to verify the detection and quantification of glucose in a blood sample. The system described by Fuller et. al. may be included within the device of the present invention so that the one or more analytes within the sample are characterized using one or more detection methods. Alternatively, the sample holder may be measured using the devices described herein, and then inserted within a receptor of a second apparatus for further analysis, for example as described by Fuller et. al.

The device and method described in U.S. Pat. No. 7,315,767 to Caduff et al. may also be used to complement the data obtained on select analytes using the apparatuses of the present invention. Caduff et al. disclose a method for measuring the concentration of substances in a specimen, for example, the measurement of glucose in a human body, wherein a modulated electrical voltage signal is applied to an electrically insulated electrode that is positioned at the specimen to generate a modulated field in the specimen. Certain parameters reflective of the response of the specimen/human body to the field is measured in order to determine the concentration of certain substances, such as glucose in the specimen. The system described by Caduff et. al. may also be included within the device of the present invention so that the one or more analytes within the sample are characterized using one or more detection methods. Alternatively, the sample holder may be measured using the devices described herein, and then inserted within a receptor of a second apparatus for further analysis, for example as described by Caduff et. al.

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

One or more currently preferred embodiments of the invention have been described by way of example. The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

What is claimed is:

1. An apparatus for determining the characteristics of one or more analytes in one or more sample, comprising,
an electromagnetic radiation (EMR) source;
a receptor in optical communication with the EMR source, the receptor for receiving a sample, detecting if the sample has been presented to the receptor in a predefined manner, and directing EMR received from the EMR source at the one or more sample;
a detector in optical communication with the receptor, the receptor for measuring transmitted, reflected, scattered EMR, or a combination thereof by the sample received from the receptor;
a user interface for presenting information respecting the presentation of the sample to the receptor and the characteristics of one or more analytes in the sample; and
a communications unit in operative association with the detector for transmitting the characteristics of one or more analytes in the sample to a processor.

2. The apparatus of claim 1, wherein the apparatus further comprises one or more spectrophotometers in communication with the receptor, detector and user interface, the spectrophotometer for determining one or more property of one or more analytes in the sample based on the measured reflected or scatted EMR received from the detector, directing the user interface to present information received from the receptor respecting the presentation of the sample to the receptor, and directing the user interface to present information respecting the one or more property of one or more analytes in the sample determined by the processor.

3. The apparatus as defined in claim 1, wherein the communications unit is in operative communication with a corresponding communications unit in a hand held device, a cell phone, a mobile device, or a computing device.

4. The apparatus as defined in claim 1, wherein the apparatus is housed within a hand-held device, a cell phone, a mobile device, or a computing device.

5. The apparatus of claim 3, wherein the hand held device, cell phone, mobile device, or computing device, comprises a processor, the processor comprising application software for determining one or more property of the analyte, and a user interface,

6. The apparatus of claim 1, wherein the receptor comprises a glide path or channel for directing the sample into proper orientation with the receptor.

7. The apparatus of claim 1, wherein the receptor further comprises a warning system to notify a user whether a finger, a body part, or a sample holder has not properly covered over the aperture of the receptor.

8. The apparatus of claim 2, wherein the one or more property of the analyte is transmitted to a second computing device wirelessly.

9. The apparatus of claim 2, wherein the one or more property of the analyte is transmitted to a second computing device over the internet

10. The apparatus of claim 2 wherein the apparatus comprises one or more fibre optics connectors in optical communication with the EMR, each of the one or more fibre optics providing one or more different wavelengths of EMR to one or more ports within the receptor, the receptor further comprising one or more outlet ports coupled to one or more output fibre optics each in optical communication with one or more spectrometers.
